(19) United States
(12) Patent Application Publication
(10) Pub. No.: US 2011/0085075 A1
(43) Pub. Date: Apr. 14, 2011

(54) Method for Imaging an Object

(75) Inventors: Ronald Antonius Hoebe, Amersfoort (NL); Erik Martinus Marie Manders, Monnickendam (NL)

(73) Assignees: ACADEMISCH MEDISCH CENTRUM BIJ DE UNIVERSITEIT VAN, AMSTERDAM (NL); UNIVERSITEIT VAN AMSTERDAM, AMSTERDAM (NL)

(21) Appl. No.: 12/937,102

(22) PCT Filed: Apr. 7, 2009
(86) PCT No.: PCT/NL09/50182

§ 371 Date: Dec. 20, 2010

(30) Foreign Application Priority Data
Apr. 10, 2008 (NL) 2001464

(51) Int. Cl. H04N 5/225

(52) U.S. Cl. 348/370; 348/E05.029

(57) ABSTRACT

The invention relates to a method for imaging an object, comprising the illumination of the object, and the detection of light coming from an area where the object is located and, based on the detected light, forming the image, with the illumination of the object taking place by distinguishing image elements in an imaging plane or space, and by separately illuminating the object parts corresponding with these image elements, while simultaneously registering the applied illumination dose of these object parts, and wherein the image is subsequently constructed by assembling the image elements corresponding with the illuminated object parts, subject to the light output and illumination doses pertaining to those image elements, wherein the illumination dose of each separate object part depends at least on a light output and/or illumination dose of another object part or several other object parts.

The invention relates to a method for imaging an object, comprising the illumination of the object, and the detection of light coming from an area where the object is located and, based on the detected light, forming the image, with the illumination of the object taking place by distinguishing image elements in an imaging plane or space, and by separately illuminating the object parts corresponding with these image elements, while simultaneously registering the applied illumination doses of these object parts, and wherein the image is subsequently constructed by assembling the image elements corresponding with the illuminated object parts, subject to the light output and illumination doses pertaining to those image elements.

The invention also relates to an apparatus for imaging an object, comprising an illumination organ for illuminating the object, and a detector for illuminating the object, and a detector for detecting light coming from an area where the object is located, which apparatus is provided with a directing organ for selectively directing light from the illumination organ to a portion of the object, wherein the illumination organ is controllable and is connected with a regulator that is coupled with the detecting organ, and which regulator controls the illumination organ subject to the light being detected by the detecting organ. This comprises the situation that all image elements are illuminated simultaneously, but with an illumination dose as determined for each image element separately. This is the situation with wide-field-microscopy.

Such a method and apparatus are known from the Dutch patent application NL-A-1023440, published on 17 Nov. 2004.

In the known method and apparatus for imaging an object, the object is illuminated by distinguishing image elements in an imaging plane or space, and by illuminating the object parts corresponding with these image elements until for each image element separately a predetermined first threshold value of the detected light output is reached, while likewise for each separate image point an applied illumination time is registered, and that subsequently the image is constructed by determining for each image point separately a calculated light output value, which depends on at least one predetermined illumination parameter.

In this way it is possible to provide for each separate image point a controlled illumination, with the illumination always being adapted to the amount of light necessary for precise and adequate imaging. Parts of the object that require only little illumination are thus protected from too much light, while object parts that are more deficient in light receive an adapted increased illumination. When used for the study of cell material, it is thus possible to avoid damage to the DNA-structure and other structures such as proteins and fatty acids of the illuminated cell parts. However, apart from this life-science application the invention is, also useful in an other way, for example, with radio diagnostics or with microchip production.

With some of the image elements, the known method and apparatus appear to produce faulty illumination results, especially at low signal/noise ratios, so that some of the object parts are inadvertently insufficiently illuminated, while likewise inadvertently, locations where there is no object part to be illuminated may be illuminated in excess. In the reproduction of the image of the object this is visible as small holes while the background of the object in some places lightens up incorrectly.

The object of the invention is to avoid this problem.

To this end the method and apparatus according to the invention is characterized by one or several of the appended claims.

The most general feature characterising the method according to the invention, is the aspect that the illumination dose of each separate object part depends at least on a light output and/or illumination dose of another object part or several other object parts. These other object parts may be either close by or at some distance from the actual object part to be illuminated.

Correspondingly, the regulator being part of the apparatus according to the invention is designed such that the apparatus executes the above-mentioned method according to the invention.

By selecting the afore-mentioned illumination dose for each object part separately it is possible to determine this illumination dose with greater precision, so that holes in the image of the object and unnecessarily illuminated parts surrounding it will occur less frequently.

The apparatus and method according to the invention are useful in various kinds of microscopic systems. These may include single-focus confocal microscopy, multifocus confocal microscopy (Nipkov-disc), but also wide-field microscopy applications. As already mentioned above, the invention is also useful outside the field of microscopy.

To determine the illumination dose of an object part it is possible to use the light output and/or illumination dose of another object part situated near the respective object part, but also of object parts that are situated further away. The data from the same object part obtained at a different moment in time may also be used.

In a first preferred embodiment the method and apparatus according to the invention are characterized by the fact that the illumination dose of each separate object part also depends on that object part's light output measured during illumination.

It is generally preferred for the illumination dose of each separate object part to depend on the light output of that object part and on the light output and/or illumination dose of one or several other object parts in a relative to each other predetermined ratio.

In another preferred embodiment the method and apparatus according to the invention are characterized by the fact that the illumination dose of each separate object part is determined subject to the illumination doses and related measured light outputs of several neighbouring object parts. In general the illumination dose may be predetermined on the bases of a mean value of the illumination dose and the respective light outputs of the respective neighbouring object parts. For the sake of clarity, it should be noted that “neighbouring” should in this case be understood as “in the vicinity of” without necessarily meaning that these object parts are directly next to each other.

Attention is further drawn to the fact that the illumination dose is adjusted for each object part separately according to a predetermined choice regarding illumination time and illumination intensity. It may be preferred to regulate the light dose on the basis of an adjustment of the illumination intensity, while maintaining a set illumination time. The advantage of this is that a lower illumination intensity can be used, causing less photo damage to an object to be illuminated.

The invention is also embodied in software for a computer being part of an apparatus to allow the same to operate in accordance with the method explained above.

Hereinafter the invention will be further elucidated by way of two preferred embodiments of the method and apparatus according to the invention, and with reference to the drawing.

The drawing shows in:

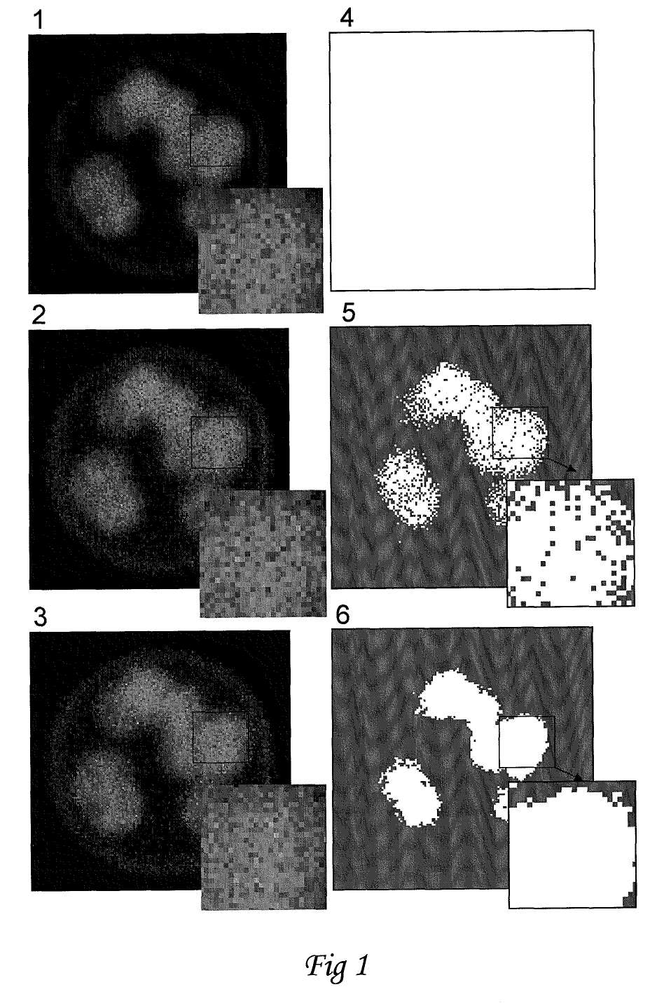

FIG. 1 a number of images pertaining to illumination and reproduction of an object in the traditional manner and using the technology described in NL-A-1023440, and according to the present invention, respectively.

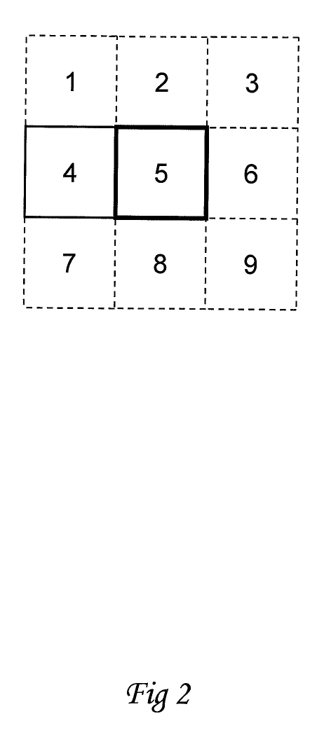

FIG. 2 a number of adjacent image elements pertaining to the method according to a first preferred embodiment, and

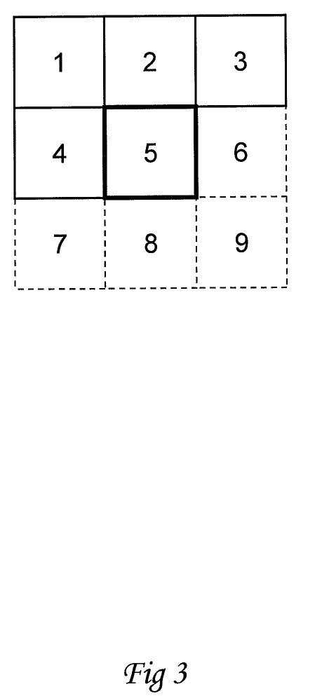

FIG. 3 a number of adjacent image elements pertaining to the embodiment of the method according to the second preferred embodiment.

The physical components of the apparatus according to the invention are entirely in concurrence with the components of the apparatus described in NL-A-1023440, the contents of which are herewith considered to be inserted in their entirety.

### FIRST PREFERRED EMBODIMENT

With reference to FIG. 2, a very schematic application of the method according to the invention in a first preferred embodiment is shown, in which the decision concerning an illumination dose to be used with an illumination element depends on only one neighbouring image element. To this end FIG. 2 shows a square of nine image elements, of which the image elements numbered 1-4 have already been illuminated. For image element 5, the illumination intensity has to be determined at that moment, after which the illumination intensity of image elements 6-9 will be determined successively.

In this first preferred embodiment, solely the illumination intensity of image element no. 4 is involved in determining the illumination intensity of image element no. 5.

If this is executed in a so called “scanned system” in the form of a confocal microscope, then during the registration of the measured light output of image element 5 a value representative of the previously measured light output of image element 4 will be added to that signal. One thing and another may take place at a previously determined ratio. For example, the signals that are representative of the light output from image element 4 and image element 5 may be weighed proportionally, but it is also possible to use a ratio wherein the value from, for example, image element 4 weighs less heavily, for instance 20%, as opposed to the measured light output of image element 5 (80%).

### SECOND PREFERRED EMBODIMENT

In the second preferred embodiment, which is explained below with reference to FIG. 3, the illumination dose for image element 5 can be determined on the basis of the measured light output of the image elements 1, 2, 3 and 4. To this end the average of the light output of these image elements 1-4 can be calculated and used as the expected value for image element 5.

If the expected calculated value is low, image element 5 will be considered to probably not pertain to the object, so that the illumination dose can be reduced. If the expected value is high, on the other hand, the pertaining illumination dose will be high.

To determine the expected value it is not necessary to only consider the arithmetical average of the illumination output of the image elements 1-4, but it is also possible to use a weighed average or the median of the measured values.

The determined expected value for the image element 5 may be used for a prior adjustment of the illumination dose based on a to be selected illumination time and/or illumination intensity. It is preferred for the illumination dose to be finally used for image element 5 to be adjusted with the light intensity while maintaining a set illumination time. In this way the damage to the biological sample to be illuminated can be limited.

### RESULTS

With reference to FIG. 1, some results are shown of the method and apparatus according to the invention in comparison with the prior art.

In FIG. 1 an image of an object is shown carrying reference numeral 1, recorded with a standard technology without using the imaging known from NL-A-1023440. All the image elements are recorded with an unregulated and set illumination dose, represented in Figure section 4 by a completely white square.

Figure section 2 relates to the recording of the same object using the imaging technology described in NL-A-1023440. The reproduction of the object shows holes visible as dark pixels surrounded by lighter pixels. These darker pixels have erroneously been illuminated as background pixels with too low an illumination dose. The illumination dose of these pixels is shown in Figure section 5 as dark dots.

Figure section 3 relates to the imaging method according to the present invention. The represented object as shown in Figure section 3 is again the same as in the Figure sections 1 and 2, and is now without holes in the object due to the fact that all the relevant image elements have received an adequate illumination dose. This is represented in Figure section 6, showing that there are practically no holes left in the object.

1. A method for imaging an object, comprising the steps of:
illuminating the object by distinguishing image elements in an imaging plane or space, and by separately illuminating object parts corresponding with these image elements, while simultaneously registering the applied illumination doses of these object parts;
detecting light coming from the object; and,
based on the detected light, forming an image by assembling the image elements corresponding with the illuminated object parts, subject to the light output and illumination doses pertaining to those image elements,
wherein the illumination dose of each separate object part depends at least on a light output and/or illumination dose of another object part or several other object parts.

2. The method according to claim 1, wherein the illumination dose of each separate object part also depends on that object part's light output measured during illumination.

3. The method according to claim 1, wherein the illumination dose of each separate object part depends on the light output of that object part and on the light output and/or illumination dose of one or several other object parts in a relative to each other predetermined ratio.

4. The method according to claim 1, wherein the illumination dose of each separate object part is determined subject to the illumination doses and related measured light outputs of several neighboring object parts.

5. The method according to claim 1, wherein the illumination dose is adjusted for each object part separately according to a predetermined choice of illumination time and illumination intensity.

6. An apparatus for imaging an object, comprising:
an illumination organ for illuminating the object,
a detector for illuminating the object,
a detector for detecting light coming from the object, and
a directing organ for selectively directing light from the illumination organ to a portion of the object,
wherein the illumination organ is controllable and is connected with a regulator that is coupled with the detecting organ, and which regulator controls the illumination organ subject to the light being detected by the detecting organ, and
wherein in use the regulator adjusts the illumination dose of each separate object part such that it depends at least on a light output and/or illumination dose of another object part or several other object parts.

7. The apparatus according to claim 6, wherein the regulator is designed such that the illumination dose of each separate object part also depends on that object part's light output measured during illumination.

8. The apparatus according to claim 6, wherein the regulator is designed such that the illumination dose of each separate object part depends on that object part's light output and on the light output and/or illumination dose of one or several other object parts in a relative to each other predetermined ratio.

9. The apparatus according to claim 6, wherein the regulator is designed such that the illumination dose of each separate object part is determined subject to the illumination doses and related measured light outputs of several neighboring object parts.

10. The apparatus according to one of the claims 6-9, wherein the regulator is designed such that the illumination dose is adjusted for each object part separately according to a predetermined choice regarding illumination time and illumination intensity.

11. Software for an apparatus according to claim 6, to allow the apparatus to operate in accordance with the method of claim 1.
